(19) United States
(12) Patent Application Publication
(10) Pub. No.: US 2009/0076839 A1
(43) Pub. Date: Mar. 19, 2009

(54) SEMANTIC SEARCH SYSTEM

(76) Inventors: Klaus Abraham-Fuchs, Erlangen (DE); Sultan Haider, Erlangen (DE); Georg Heidenreich, Erlangen (DE); Volker Schmidt, Mohrendorf (DE); David Wolfgang Eberhard Schmidt, Erlangen (DE); Dominic Pascal Schmidt, Erlangen (DE)

Correspondence Address: BRINKS HOFER GILSON & LIONE, P.O. BOX 10395, CHICAGO, IL, 60610, US

(21) Appl. No.: 11/855,594

(22) Filed: Sep. 14, 2007

(51) Int. Cl. G06Q 50/00; G06F 17/27

(52) U.S. Cl. 705/2; 704/9

(57) ABSTRACT

A semantic search is provided. The semantic search generates related terms that relate to a search term using a selected ontology domain. The related terms may be compared to information in a medical document. The semantic search may also generate related terms for the medical document. The related terms for the medical document may be compared to the related terms that relate to the search term.

### BACKGROUND

The present embodiments relate to a semantic search of medical data. In particular, the semantic search uses a selected ontology domain to expand a search term into a plurality of related terms.

A medical database may store medical information. A search engine may locate information related to a search term. A traditional search engine locates medical information by comparing letters of the search term to letters of the medical information. This is a lexical comparison.

A lexical comparison of a search term and the medical information fails to locate relevant data. A lexical comparison is based on the words located in the search term and is limited to such words. For example, if a user is searching for medical information relating to a fever, and enters a search term “high temperature,” the search engine may not locate information about a fever because the letters in “high temperature” do not correspond to the letters in fever. Even though “high temperature” is a symptom of a fever and may be relevant, the search engine may not locate relevant data.

A lexical comparison of a search term and the medical information locates non-relevant hits. A lexical comparison is not restricted to an application domain. At least initially, a search engine using a lexical comparison compares the search term to information in all application domains. The lexical comparison locates and produces false hits based on these comparisons. For example, a lexical comparison of “high temperature” may locate results relating to the medical field, automobile field, chemistry field, weather field, and other independent fields. A user is then required to manually search the located information and determine the relevant results. There is a need for a search system that increases the number of relevant hits and/or decreases the number of non-relevant hits.

### BRIEF SUMMARY

By way of introduction, the embodiments described below include methods, systems, and instructions for use of a medical ontology for searching a medical document. The present embodiments relate to a semantic search of medical data. The semantic search uses a selected ontology domain to expand a search term into a plurality of related terms. The related terms are compared to the medical data. Alternatively, the semantic search may also associate related terms from a selected ontology domain to relevant terms in the medical data. The related terms associated with the search term are compared to the related terms associated with the medical data.

In a first aspect, a method uses an ontology to search a medical record. The method includes selecting a domain in the ontology; translating, with a processor, a search term into a semantic base using identified related terms in the selected ontology domain; and searching a medical record as a function of the semantic base.

In a second aspect, a method translates a term of interest using an ontology. The method includes assuming a domain in the ontology; identifying, with a processor, a plurality of semantic terms from the assumed domain in the ontology, the semantic terms relating to the term of interest; and associating, with the processor, the term of interest and the identified semantic terms.

In a third aspect, a computer readable storage media stores data representing instructions executable by a programmed processor for use of an ontology for searching a medical record for a search term. The storage media includes instructions for selecting a domain in an ontology; identifying related terms relating to the search term in the selected ontology domain; and building a search engine operable to search medical data as a function of the related terms and the search term.

In a fourth aspect, a system includes a memory operable to store an ontology; and a processor operable to translate a search term as a function of identified related terms in a selected ontology domain, the related terms relating to the search term.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

FIG. 1 is a block diagram of one embodiment of a system for use of a medical ontology for searching a medical database.

FIG. 2 is a block diagram of one embodiment of a memory.

FIG. 3 illustrates one embodiment of an ontology.

FIG. 4 is a flow chart diagram showing one embodiment of a method for searching a medical record as a function of a translated search term.

FIG. 5 is a flow chart diagram showing one embodiment of a method for translating a term of interest.

FIG. 6 is a flow chart diagram showing one embodiment of a method for comparing a translated search term to a translated medical record.

FIG. 7 is one embodiment of a system for searching a medical database.

FIG. 8 is one embodiment of a system for searching a medical database.

### DETAILED DESCRIPTION

In one embodiment, a semantic-based search includes explicitly restricting a given search engine or a given search request to a domain or a conceptual model (e.g., classification) within a domain. A search engine translates entered search terms using one or more domain-related ontologies. The translation identifies related terms for a given search term using the one or more domain-related ontologies. The search engine compares the resulting related terms with the concepts derived from similarly translated terms of the documents examined using the same ontologies. This comparison is completed on the level of domain-specific semantics instead of dealing with literal comparisons.

A search engine builds and manages indices for representing preprocessed search results. The indices are structured according to semantical classifications. These classification are established in the respective domain (e.g., medical) and differentiate separated concepts while unifying synonyms. The domain-related indices are restricted to a conceptual domain. The search engine first translates the terms using ontologies into conceptual terms describing the intended semantics expressed by the same classifications used in existing domain-related indexes and then uses the related terms to search in such indices.

The search engine may compare single words and search terms (e.g., from the query or derived from translating the query) expressed via relationships and complex logical expressions with similar expressions stored in a database or derived from similarly translating documents to be searched for.

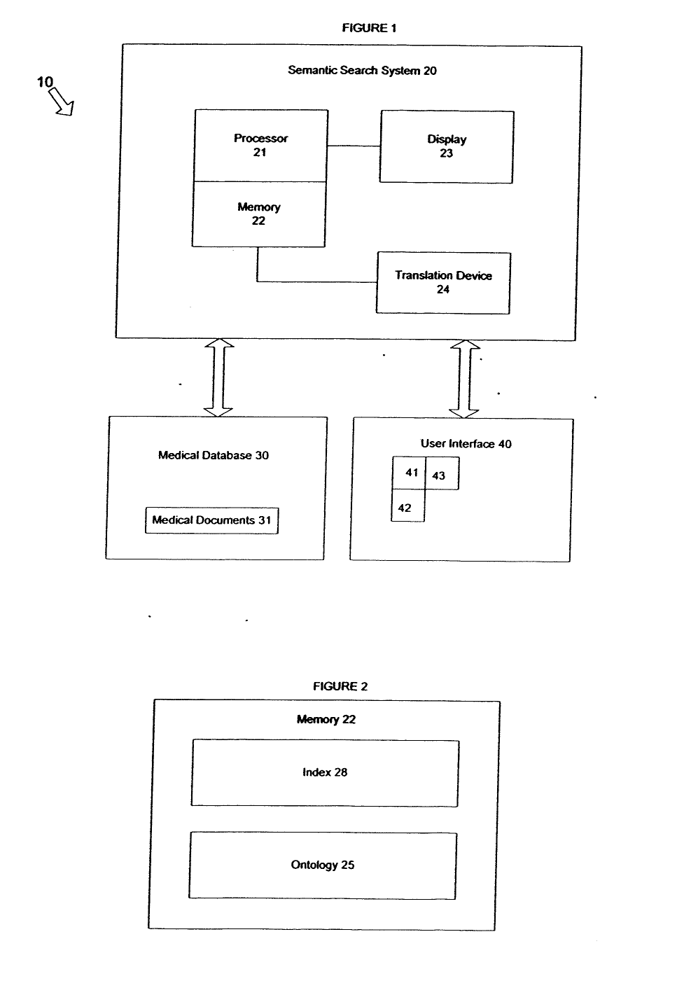

FIG. 1 shows a system 10 for searching a medical document. The system 10 includes a semantic search system 20, a medical database 30, and a user interface 40. Additional, different, or fewer components may be provided. For example, the system 10 may include a semantic search system 20 connected to a display 23 and a medical database 30. The system 10 operates to semantically search medical documents 31 in the medical database 30 using a search term provided from the user interface 40. The semantic search system 20 communicates with the medical database 30 and the user interface 40 wirelessly or using dedicated communication lines. For example, the semantic search system 20 may send and receive communications via a cable, the Internet, or communication circuits.

The semantic search system 20 may include a processor 21 and memory 22. Additional, different or fewer components may be provided. For example, the semantic search system 20 may also include a display 23 connected to the processor 21. In another example, the semantic search system 20 includes one or more translation devices 24 connected to the processor 21 and memory 22.

The semantic search system 20 is a personal computer, workstation, network, imaging system, server, or other now known or later developed system for searching a medical document. For example, the system 20 is a workstation for analyzing a medical ontology, associating semantic terms to a search term or medical document, and searching a medical document using the semantic terms.

The semantic search system 20 operates to semantically search a medical document 30. Related terms are identified for each search term. Each related term describes the search term. The semantic search system 20 uses an ontology 25 to identify the related terms. The related terms located in the ontology 25 are used to search the medical documents 31. As an alternative to searching the actual language of the medical documents 31, the semantic search system 20 may identify relevant information in the medical documents 31 and compare the search term to the related terms.

The processor 21 is a general processor, digital signal processor, application specific integrated circuit, field programmable gate array, analog circuit, digital circuit, combination thereof or other now known or later developed processor. The processor 12 may be a single device or a combination of devices, such as associated with a network or distributed processing. Any of various processing strategies may be used, such as multi-processing, multi-tasking, parallel processing or the like. The processor 12 is responsive to instructions stored as part of software, hardware, integrated circuits, film-ware, micro-code or the like.

The processor 21 may operate to analyze a search term. The processor 21 may receive a search term from the user interface 40. For example, a search term may be provided to the processor 21 from a user searching for information. Examples of search terms may include: “symptoms of a severe fever,” “Jane has a high temperature,” “high temperature,” or “temperature.” The search term may define the information that a user is attempting to locate.

The processor 21 may identify one or more term of interest in the search term. For example, for the search term “symptoms of a fever,” the processor 21 may identify “symptoms” and “severe fever” as two separate terms of interest. A term of interest is, for example, a term located in a selected ontology domain, information deemed relevant to the search, or information leading to a desired result. For identifying a term of interest, a processor 21 may analyze an ontology, a stored list, software, or other documents that identify terms of interest. A match indicates a term of interest.

The processor 21 may select a domain or classification in an ontology. An ontology is a set of relationships. Example ontologies include MeSH, UMLC, and Snomed CT. Other now existing or later developed ontologies may be used. Different ontologies provide different relationships. For example, one ontology may be used for one type of information, such as symptoms, another ontology used for another type of information, such as a rule-set, and another ontology used for another type of information, such as “IS A” relationships. Ontologies may be used for symptom, cause, effect, signs, other concepts, or other features for analysis. For example, a rule-set ontology may define procedural guidelines to treat, diagnose, prepare, or examine a patient. In another example, medical ontologies provide computer assisted clinical decision support.

An ontology may include categories of information. The information may be categorized into different groups. Each group may include sub-groups or additional categories. The information in each group or sub-group is not limited. For example, an ontology may include information related to different fields, such as medical, weather, or other field of information. The medical group may include sub-groups, such as cancer, broken bone, or other field of information. The cancer sub-group may include sub-groups or additional categories, such as colon cancer, liver cancer, oral cancer, or other fields of cancer. Each sub-group may include another sub-group. Each sub-group may, additionally or alternatively, include related terms to each group or sub-group.

Referring to FIG. 3, an ontology 25 may include domains, classifications, and related term. Additional, different, or fewer categories may be provided. For example, sub-classifications may be included in an ontology.

The ontology 25 may include one or more domains. A domain may be a high level category of information, such as a general field. For example, a domain may be classified as medical information, automobile information, sport history information, or other high level classifications. As an alternative to different field domains, an ontology may include one type of information, such as medical information. A medical ontology may include domains with different groups of information relating to the medical field. For example, a medical ontology domain may include information relating to a medical term, medical billing classification, medical diagnosis guideline, medical treatment, or other medical information.

The ontology 25 may include one or more classifications. A classification may be a sub-group of the domain. For example, a classification such as “High Temperature” may be related to medical information, so is placed in the medical domain. Classifications may relate to medical information, such as a medical term, medical billing code, medical diagnosis guideline, medical treatment classification, or other medical information. Example classifications are: “High Temperature,” “V47.1,” or “If headache, then medicine.” An ontology classification may be a relationship link between the domain and a related term. For example, related terms may describe or relate to a classification. The relationship link may include one or more classifications. For example, the ontology may include one, two, three, or more classification links between the domain and the related terms.

The ontology 25 may include related terms. Related terms may semantically define a classification or domain. For example, the related terms may describe or relate to a classification or domain. Related terms provide alternative descriptions of the classification or domain to which they are relationally linked. For example, as shown in FIG. 3, in Domain 2, the related terms, “Fever” and “Heat Shock,” are semantic descriptions of the classification, “High Temperature.” A related term may be closely related to the classification that it describes. The ontology may define the relationship between the related terms and the search term or term of interest in the medical document.

The semantical relationship between related terms and classifications may be a “IS A,” “IF_THEN,” diagnosis guide, or other defined relationship. For example, as shown in FIG. 3, Domain 2 includes three classifications. The first classification C1 is a diagnosis classification. For example, a “High temperature” is a symptom that may be the caused by a “Fever” or “Heat Shock.” The second classification C2 is a “IS A” classification. For example, a “Heart” is a “Organ” and a “Blood Pump.” The third classification C3 is a rule-set, such as “IF_THEN.” For example, if a “Headache” then “Take Medicine” or “Take Nap.”

Referring to FIG. 1, the processor 21 may select an ontology domain or classification. For example, the processor 21 may select a medical domain, such as Domain 2 in FIG. 3. The domain or classification is selected to limit the related terms that are identified for each term of interest. For example, as illustrated in FIG. 3, the processor 21 may select a medical domain, such as Domain 2. Unselected domains, such as Domain 1 & 3, are excluded for identifying related terms. For example, related terms in the unselected domains, such as “High Temperature” in Domain 3 of FIG. 3, will not be identified.

For selecting the domain or classification, the processor 21 may analyze a domain restriction. For example, the processor 21 may analyze a domain restriction input from a user. The input may describe the desired information, such as medical information. In another example, the processor 21 may be configured to only search a certain domain, such as the medical domain. As an alternate to processor 21 selection, the ontology may be restricted to one domain, such as a medical domain, because the ontology is a medical ontology and only includes medical information.

The processor 21 may operate to identify related terms using one or more ontologies. A search term may include one or more term of interest. Medical information in the medical documents 31 may also include one or more terms of interest. The processor 21 uses a selected ontology domain to identify related terms for a term of interest. The processor 21 locates a term of interest in the selected ontology domain or classification. The processor 21 uses the located term of interest to identify related terms that are related to the term of interest. For example, referring to FIG. 3, assuming that domain 2 is selected, the processor 21 will locate a term of interest, such as “High Temperature,” and identify the related terms relating to the term of interest, such as “Fever” and “Heat Shock.”

As an alternative to processor 21 identifying, the semantic search system 20 may include a translation device 24 in communication with processor 21 and/or memory 22. The translation device 24 identifies the search term and provides the related terms to the processor 21 and/or memory 22.

The processor 21 may independently identify related terms for each term of interest. A search term or medical document may include more than one term of interest. The processor 21 locates related terms for each term of interest. For example, the processor 21 may choose the terms of interest that will be associated with identified related terms, such as “symptoms” and “severe fever” for the search term “symptoms of a sever fever.” Each term of interest is located in a selected ontology domain and associated with the related terms semantically describing the term of interest.

The processor 21 may operate to identify related terms for a medical document 31. The processor 21 may retrieve a medical document 31 from a medical database 30. The medical document 31 may be identified based on a patient, or be from a group of documents to be processed. The medical document 31 may include one or more terms of interest. The processor 21 may identify related terms for each term of interest in the medical document 31. For example, the processor 21 locates the term of interest in the selected ontology domain and identifies the related terms that semantically describe the term of interest.

As an alternative to a processor 21 identifying the related terms for the medical document 31, the semantic search system 20 may include a translation device 24 in communication with processor 21 and/or memory 22. The translation device 24 identifies the related terms for the medical document 31 and provides the related terms to the processor 21 and/or memory 22.

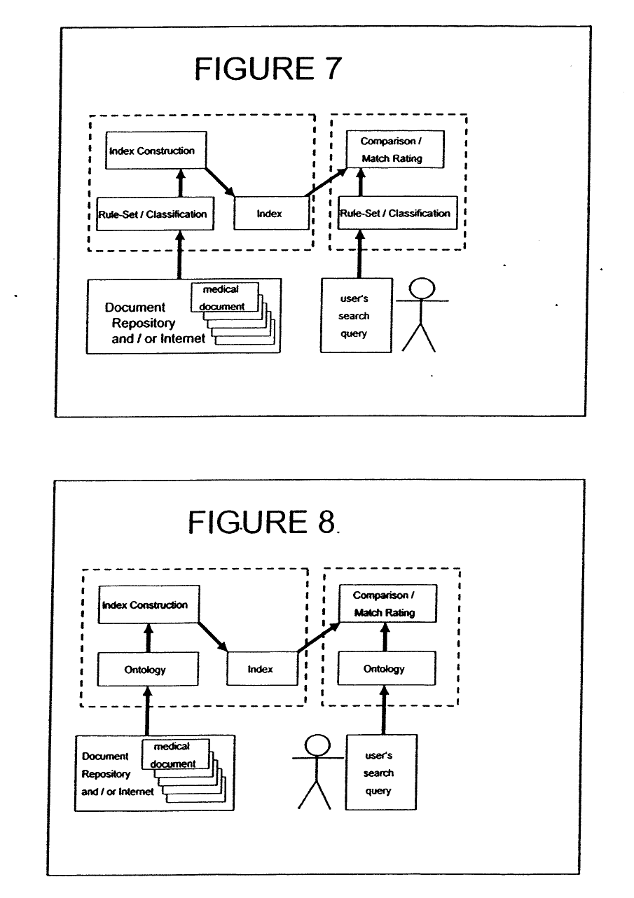

The processor 21 is operable to construct an index 28. The index 28 may include related terms from the medical documents 31. For example, as shown in FIG. 7, the related terms may be stored in the index 28. The stored information may include the term of interest and the related terms identified by the processor 21 using an ontology 25. In another example, the index 28 may include an address of a location in a medical database 30, where the medical information is stored. The address may be used to locate the medical documents 31.

The processor 21 is operable to search the medical document 31 as a function of a related term and/or term of interest. For example, the processor 21 compares the term of interest or related term to words of the medical document 31. The processor 21 may use any now known or later created search engine. For example, the processor 21 may use a lexical comparison to compare the related terms of the term of interest to the medical document 31. In another example, the processor 21 may use a search that matches all or a portion of a related term or term of interest, such that a general data entry will match a more specific query term. As an illustration of this example, an ICD code V47.1 may be matched with “V47,” V4,” or “V.” A result is created when the search engine locates a successful comparison or match.

In an alternate embodiment, the processor 21 is operable to search related terms of the medical document 31 as a function of a related term of the term of interest. For example, related terms of the term of interest are compared to the related terms relating to the medical document 31. In another example, a term of interest is compared to one or more related term associated with the medical document.

The memory 22 may store an ontology 25, index 28, and data representing instructions executable by the processor 21. Additional, different, or fewer components may be stored. For example, the related terms associated with terms of interest may be additionally stored in the memory 22.

The memory 22 is a computer readable storage media. Computer readable storage media include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 22 may be a single device or a combination of devices. The memory 22 may be adjacent to, part of, networked with and/or remote from the processor 21.

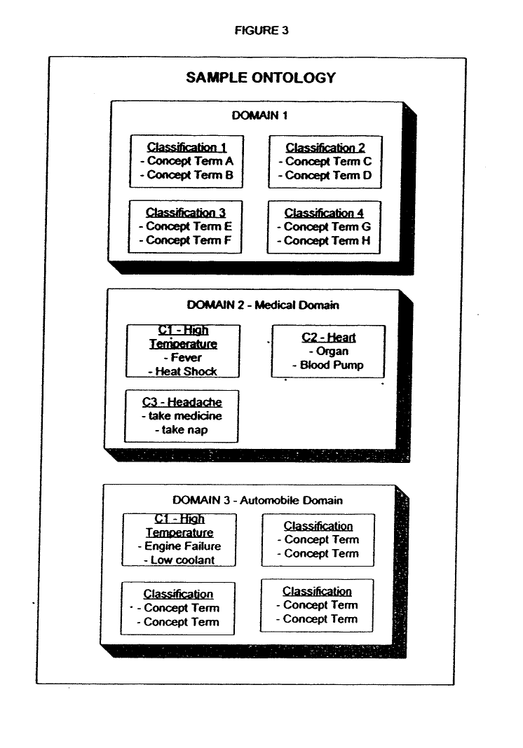

As shown in FIG. 2, the memory 22 may store an ontology 25. For example, a spreadsheet of the ontology terms and relationships is stored. An ontology may be scanned and/or OCRd for storage into the memory. The memory 22 may store information extracted from an ontology, such as associated terms, relationships, domain knowledge, related terms, or combinations thereof.

As shown in FIG. 2, the memory 22 may store an index 28. The index 28 may include information for the medical documents 31. The information may include one or more related terms, an address, and a term of interest. The index 28 may be organized based on an ontology 25, such as ICD or SNOMED. Alternatively, the index 28 may be a combination of two or more ontologies.

The memory 22 may be a computer readable storage media having stored therein data representing instructions executable by the processor 21 for use of a medical ontology for searching a medical database 30. The storage media may include instruction for selecting a domain in an ontology; identifying related terms relating to the search term in the selected ontology domain; and/or building a search engine operable to search medical data as a function of the related terms and the search term. Additional, different, or fewer instructions may be provided. For example, the storage media may include instructions for identifying related terms for medical data. The storage media may also include instructions for comparing concepts terms of a search term to related terms of

The semantic search system 20 may include a display 23. The display 23 is a CRT, monitor, flat panel, LCD, projector, printer, or other now known or later developed display device for outputting determined information. The processor 21 may cause the display 23 at a local or remote location to output data indicating search results, a possible diagnosis, a probability associated with one or more possible diagnoses, an image with marked locations of interest, or medical record information.

The medical database 30 may include one or more medical documents 31 and an address. Additional, different, or fewer components may be included. For example, the medical database 30 may include an access portal that restricts access to the medical documents 31.

The medical database 30 may include one or more medical documents 31. The medical documents 31 may include patient-related information, medical guidelines, medical billing procedures, medical diagnosis procedures, or other medically related information. The medical documents 31 may include medical text, medical images, or the combination thereof.

The medical database 30 may include an address. The address may be used to locate the medical documents 31. The accessible address may be an Internet address, server address, network address or other accessible address. For example, the Internet address may be a URL:// address. A communication device may communicate with the medical database 30 using the server address. For example, the user interface 40 may use the server address to communicate with the medical database 30.

The user interface 40 may include a user processor 41, a user memory 42, and a user display 43. Additional, different, or fewer components may be provided. The user interface 40 is a personal computer, workstation, or other now known or later developed system for providing support to a user.

The user interface 40 operates to display a search term transmitted to the semantic search system 20, search results, or locate medical documents 31. For example, the user interface 40, via the user display 43, may display the search results to a user. The search results may include a link (e.g., a reference) to the medical document 31 in the medical database 30. A user may view the search results using the user interface 40. The search results may be ranked according to a rating. The user may browse the list of search results using summaries provided in the listings. The user may select one of the search results. By selecting a search result, the user may be directed to the medical document 31.

The user interface 40 may communicate with the semantic search system 20. For example, the user processor 41 may communicate an inputted search term to the processor 21 via a cable, the Internet, or other communication circuit. Alternatively, the semantic search system 20 may return the search results to the user interface 40. The search results may be stored in the user memory 42. The search results may be displayed on the user display 43. In an alternate embodiment, the user interface 40 may include the semantic search system 20.

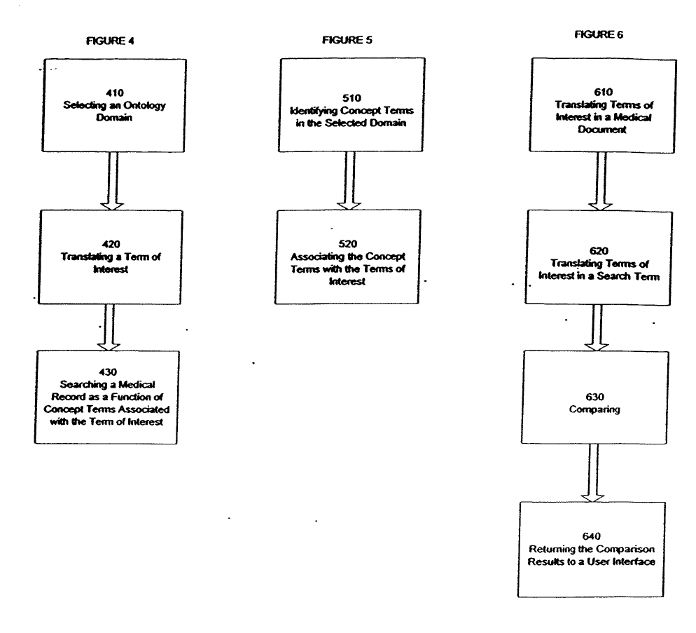

FIG. 4 shows a method for use of an ontology for searching a medical database. The method is implemented using the system 10 of FIG. 1 or a different system. Additional, different or fewer acts than shown in FIG. 4 may be provided. For example, the method may additionally include returning the search results to a user interface.

In act 410, an ontology domain or classification is selected. An ontology domain may be selected using a user interface 40 or providing a processor 21 access to only a certain type of ontology, such as a medical ontology. For example, a processor 21 may select an ontology domain based on a search term. In another example, the ontology domain is pre-selected by the system 10. In another example, the user manually selects the ontology domain. In another example, a user requests a certain ontology domain using the user interface 40. The processor 21 selects an ontology domain as a function of the user's request. Selecting an ontology domain narrows the related terms identified for a term of interest. As an alternative to selection of a single ontology domain or classification, multiple ontology domains or classifications may be selected.

In act 420, a semantic base is built using a selected ontology domain. A search term or medical document 31 may be provided to the processor 21. For example, a search term may be transmitted from a user interface 40 to the processor 21 or semantic search system 20. In another example, a copy of medical document 31 is transmitted from a medical database 30 to the processor 21 or semantic search system 20.

The processor 21 may identify the term of interest in a search term or a medical document 31. The processor 21 identifies terms in a search term or a medical document 31 that are also in the selected ontology domain. For example, a processor 21 may use a list of terms in the selected ontology domain to identify a term of interest. As an alternative to identifying a single term of interest, the processor 21 may identify a plurality of terms of interest in the search term or the medical document 31.

FIG. 5 shows an expanded view of one exemplary embodiment of act 420. In act 510, related terms are identified in the selected ontology domain for the term of interest. The processor 21 may locate the term of interest in the selected ontology domain. Related terms, which are semantically related to the located term of interest, are identified. In act 520, the related terms are associated with the term of interest. A semantic base may include the association between the related terms and the term of interest.

Referring to FIG. 4, in act 430, one or more medical documents 31 are searched as a function of the semantic base. The medical document 31 may be searched as a function of each related term. For example, if related terms A, B, and C were identified, the processor 21 would search the one or more medical documents 31 for related term A. The processor 21 would, subsequently or simultaneously, search the one or more medical documents 31 for related term B. Similarly, the processor 21 would search the one or more medical documents 31 for related term C. In addition to searching for related terms, the processor 21 may search one or more medical documents 31 for the term of interest, which was used to identify the related terms.

The search results may be transmitted to the user interface 40. After searching the medical documents 31 for the related term, the located results may be transmitted to the user interface 40 or other system or memory. The search results may include a reference to the location of the medical documents 31 in the medical database 30. For example, a user of the user interface 40 may use the search results to navigate to the medical documents 31.

The search results may be rated. A search of the one or more medical documents 31 may return results that partially or entirely match the term of interest or related terms. The search may be rated in any way. For example, a match of the term of interest in the one or more medical documents 31 may receive a higher rating than a match of a related term. A rating may be used to list the search results. For example, a higher rating may be listed above a lower rating, or vice versa.

FIG. 6 shows a method for use of an ontology for searching one or more medical documents 31. The ontology is used to identify related terms for the one or more medical documents 31 and a search term. The method is implemented using the system 10 of FIG. 1 or a different system. Additional, different or fewer acts than shown in FIG. 6 may be provided. For example, a medical document 31 may be transmitted from a medical database 30 to a semantic search system 20. The acts are performed in the order shown or a different order. For example, act 610 may be performed before or after act 620. The acts may be performed automatically, manually, or as combinations thereof.

In act 610, related terms for a term of interest in a medical document 31 are identified. A medical document 31 may be retrieved from a medical database 30. The medical document 31 may include one or more terms of interest. The processor 21 may identify each term of interest in the medical document 31. Related terms are identified for each term of interest. For example, the processor 21 may locate the term of interest in a selected ontology domain. The processor 21 may identify related terms in a selected ontology domain relating to the terms of interest. The processor 21 associates the identified related terms with the terms of interest. The associated terms may be stored together, for example, in the memory 22. Alternatively, the associated terms may be compared, in real time, to associated related terms of a term of interest located in a search term.

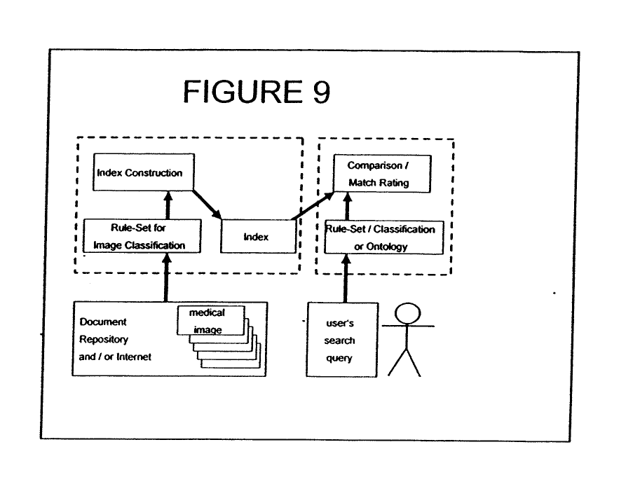

In one embodiment, as shown in FIG. 8, medical documents 31 include medical images. The medical images may include MR images, CT images, ultrasound images, or non-textual data, such as blood pressure, ECG, or EEG. The processor 21 may determine the type of data or type of image (e.g., brain image, or abdominal image) included in the medical document, such as from header information in a DICOM image. OCR or other conversion may be used to provide text in the image for processing. The processor 21 may identify related terms for this information. The processor 21 may organize the image or data into an index 28. The image or data classification may be analyzed by headers, such as normalized DICOM headers.

The processor 21 may construct an index 28 using one or more ontology 25. The processor 21 may organize the related terms for the medical document 31 into an index 28. The processor 21 stores the index 28 in a memory 22. Multiple indexing is allowed. For example, a medical document 31 may be related to more than one index at the same time. In another example, a medical document 31 may be related to a guideline and to an ICD code at the same time.

The processor 21 organizes the index 28 as a function of the related terms associated with the related terms associated with the medical document 31. For example, the related terms identified in the selected ontology domain may be stored with the term of interest. In addition to storing the associated terms, an address for a location in a medical database 30 may be stored with the associated terms in the memory 21.

The address may be used to navigate to the medical documents 31 in the medical database 30 or other document storage system. The address may be transferred to the user interface 40. For example, the processor 21 may transfer search results and the associated reference to the user interface 40 after comparing or searching the medical record, related terms associated with the medical record, or index.

In act 620, related terms for each term of interest in a search term are identified. A search term may include one or more term of interest. Related terms are identified in a selected ontology domain that relate to the term of interest. The related terms are associated with the term of interest. A search term may include the associated terms. Alternatively, the terms of interest are not translated since the index may be used based on translation of terms in the document.

In act 630, the identified related terms are compared with the related terms for the medical document 31. For example, the processor 21 searches the related terms associated with the medical document 31 as a function of the related terms for the search term. For example, the processor 21 uses a lexical search to compare the related terms to the related terms associated with the medical document 31. In another example, the processor 21 matches all or a portion of a related term associated with the search term with all or a portion of a related terms associated with the medical document 31.

A processor 21 may search an index 28 for related terms. The related terms for a medical document may be stored in an index 28. The processor 21 may compare a related term associated with a term of interest or the term of interest with information stored in the index 28. For example, the processor 21 may compare a related term of a term of interest to a related term located in the index 28.

In act 640, the search or comparison results are transmitted to the user interface 40. The search or comparison result may include an address to a medical document 31 in a medical database 30. The search or comparison results may be rated for relevance. For example, the processor 21 may organize the results based on the relevance to the search term. A user may use the reference to navigate to the medical information relating to their search query or search term.

While the invention has been described with reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. A method for use of an ontology for searching a medical document, the method comprising:
selecting a domain in the ontology;
identifying, with a processor, one or more related terms in the selected ontology domain that relate to a term of interest in a search term;
searching the medical document as a function of the one or more related terms; and
outputting as a function of the searching.

2. The method of claim 1, comprising: identifying, with the processor, one or more related terms in the selected ontology domain that relate to a term of interest in the medical document.

3. The method of claim 2, wherein searching comprises: comparing one or more identified related terms that relate to a term of interest in a search term with one or more identified related terms that relate to a term of interest in the medical document.

4. The method of claim 2, comprising: organizing the identified related terms that relate to a term of interest in the medical document in an index.

5. The method of claim 4, comprising: comparing one or more identified related terms that relate to a term of interest in a search term with information stored in the index.

6. The method of claim 1, wherein selecting comprises: selecting a classification within the domain.

7. The method of claim 1, wherein identifying comprises: locating the term of interest, which is in the search term, in the selected ontology domain.

8. The method of claim 7, comprising: associating the identified related terms with the term of interest.

9. The method of claim 1, wherein the ontology is a rule-based ontology.

10. The method of claim 1, wherein searching comprises: searching the medical record as a function of the search term and related terms identified in the selected ontology domain.

11. A method for translating a term of interest using an ontology; the method comprising:
assuming a domain in the ontology;
identifying, with a processor, a plurality of semantic terms from the assumed domain in the ontology, the semantic terms relating to the term of interest; and
associating, with the processor, the term of interest and the identified semantic terms.

12. The method of claim 11, wherein assuming comprises assuming a classification within the domain.

13. The method of claim 11, wherein identifying comprises locating the term of interest in the assumed domain in the ontology.

14. The method of claim 11, comprising: storing the associated information in an index.

15. In a computer readable storage media having stored therein data representing instructions executable by a programmed processor for use of an ontology for searching a medical record for a search term, the storage media comprising instructions for:
selecting a domain in an ontology;
identifying one or more related terms relating to a term of interest in the selected ontology domain; and
running a search engine operable to search medical data as a function of the related terms and the search term.

16. The computer readable storage media of claim 15, comprising instruction for searching the medical data as a function of the one or more identified related terms.

17. A system for searching a medical record, the system comprising:
a memory operable to store an ontology; and
a processor operable to translate a search term as a function of identified related terms in a selected ontology domain, the related terms relating to the search term.

18. The system of claim 17, wherein the selected ontology domain is a medical domain.

19. The system of claim 17, wherein the processor is operable to compare the translated search term with a medical record.

20. The system of claim 17, wherein the processor is operable to translate a medical record as a function of related terms found in the selected ontology domain.

21. The system of claim 20, wherein the processor is operable to compare the translated search term with the translated medical record.

22. The system of claim 21, wherein the memory is operable to store an index of the translated medical record.

23. The system of claim 22, wherein the processor is operable to compare the translated search term with information stored in the index.

24. The system of claim 17, wherein the ontology includes a rule-set for medical procedures.

25. The system of claim 17, wherein the identified related terms include causes, effects, symptoms, signs, related diseases, body locations, morphology, or combinations thereof of the search term.
